(19) United States
(12) Patent Application Publication
(10) Pub. No.: US 2023/0259984 A1
(43) Pub. Date: Aug. 17, 2023

(54) APPRAISAL AND ASSET-BACKED LENDING SOLUTION

(71) Applicant: PROPAWN TECHNOLOGIES, LLC, MIAMI, FL (US)

(72) Inventor: Maximo Quinones, Miami Springs, FL (US)

(73) Assignee: PROPAWN TECHNOLOGIES, LLC, MIAMI, FL (US)

(21) Appl. No.: 18/105,615

(22) Filed: Feb. 3, 2023

Related U.S. Application Data
(60) Provisional application No. 63/306,179, filed on Feb. 3, 2022.

(51) Int. Cl. G06Q 30/02; G06Q 40/03

(52) U.S. Cl. CPC G06Q 30/0278; G06Q 40/03

(57) ABSTRACT

A computer-implemented system and method is disclosed to provide a technological improvement over traditional appraisal and asset-backed lending systems. The invention allows users to manage operations, general appraisal income and develop lending opportunities in a distributed and decentralized manner that is not possible in the current state of the art. In embodiments, an appraisal and asset-backed lending platform includes: a user-interface configured to run on a client-side computer that is in communication with a communications network, the user-interface adapted to admit only registered licensees to access the appraisal and asset-backed lending platform; and a computer back-end in communication with the communications network, having a database that is configured to be queried by the registered licensee via the user-interface, whereby, via the appraisal and asset-backed lending platform, a registered licensee can communicate, evaluate, locate, and lend.

### CROSS-REFERENCE TO RELATED APPLICATIONS

This application is a non-provisional of, and claims priority to, currently pending U.S. Provisional patent application No. 63/306,179, filed on Feb. 3, 2022, which is incorporated by reference as if fully set forth herein.

### FIELD OF THE INVENTION

The present invention generally relates to software and computer-implemented business methods and, more specifically, relates to a computer-implemented system and method that provides a technological improvement over traditional appraisal and asset-backed lending systems.

### BACKGROUND OF THE INVENTION

Traditionally, appraisal and asset-backed lending is conducted most commonly through pawn shops—at individual physical locations. The pawn industry as a whole is antiquated and slow to technological advances. Pawn shops typically carry large inventories that have to be catalogued and appraised. Knowledge of inventory, appraisals, and lending are all intertwined. Although it is known in the art for pawn shops to use management software, they are antiquated, and lack critical features. The current state of the art does not provide a solution for an asset-backed lender, such as a pawn shop, to communicate with the appraisal and asset-backed community at large. Current management systems do not readily enable a user to evaluate and appraise a variety of valuables in exchange for fees. The ability to locate and know the position of valuables that have been appraised with the goal of generating potential leads for asset-backed loans is another area of need in the art. Furthermore, it would be desirable to have all of the above features integrated along with lending services in a coordinated, easy to use platform.

There exists, therefore, a need for a computer-implemented system and method that provides a technological improvement over traditional appraisal and asset-backed lending systems to overcome the above-stated shortcomings of the known art.

### SUMMARY OF THE INVENTION

Disclosed herein is a computer-implemented system and method that provides a technological improvement over traditional appraisal and asset-backed lending systems to overcome the above-stated shortcomings of the known art. The system and method disclosed is a platform designed specifically to address the needs of the appraisal and asset backed lending community.

The invention allows users to leverage the technological improvements provided over the prior art in order to manage operations, general appraisal income and develop lending opportunities in a distributed and decentralized manner that is not possible in the current state of the art. We disclose a computer-implemented system and method that provides a technological improvement over traditional appraisal and asset-backed lending systems as well as over the computers it runs on.

Briefly, according to an embodiment of the present disclosure, an appraisal and asset-backed lending platform includes: a user-interface configured to run on a client-side computer that is in communication with a communications network, the user-interface adapted to admit only registered licensees to access the appraisal and asset-backed lending platform; and a computer back-end in communication with the communications network, having a database that is configured to be queried by the registered licensee via the user-interface, whereby, via the appraisal and asset-backed lending platform, a registered licensee can communicate, evaluate, locate, and lend.

Another embodiment of a computer-implemented system that provides a technological improvement over traditional appraisal and asset-backed lending systems includes: A computer back-end and computer front-end (also, a “client-side computer”) that is configured to run over a communications network. The computers are specially-programmed to run one or more computer program instruction sets (modules) and interface with one or more databases. The system provides a technological improvement over the prior art, as well as over the computers they run on, in that they are configured to provide a communication module, an evaluation module, a location module, and a lending module. Other modules, programs, or subroutines are contemplated to be included in the system, as may be known to a person of ordinary skill in the art, in order to provide the disclosed functionality. Interoperability, communication, and data transfer between modules is known in the art and improved upon as disclosed here.

Yet another embodiment, is a method of using the platform and system, where a computer-implemented method for providing a technological improvement over traditional appraisal and asset-backed lending systems, the computer-implemented method includes the steps of: providing a computer-implemented system having: a computer back-end; a computer front-end; a communications network wherein the computer back-end and the computer front-end are configured to communicate with each other over the communications network; and a one or more database accessible to either or both of the computer back-end and the computer front-end, wherein, either one or both of the computer back-end and the computer front-end are configured to provide a communication module, an evaluation module, a location module, and a lending module; communicating with the appraisal and asset-backed community using the communication module; evaluating and appraising a variety of valuables in exchange for fees using the evaluation module; locating and knowing the position of valuables that have been appraised in order to generate potential leads for asset-backed loans using the location module; and providing lending services using the lending module.

Embodiments of the system and method include a computer program product.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1a is a simplified block diagram of an appraisal and asset-backed lending platform, according to an embodiment of the present invention;

FIG. 1b is a simplified block diagram of a computer-implemented system that provides a technological improvement over traditional appraisal and asset-backed lending systems, according to an embodiment of the present invention;

FIG. 1c is a flowchart representing the method steps for a computer-implemented method for providing a technological improvement over traditional appraisal and asset-backed lending systems, according to an embodiment of the present invention; and

FIGS. 2-36 are simplified representations of screens for a client-side user-interface according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DESCRIPTION OF THE INVENTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

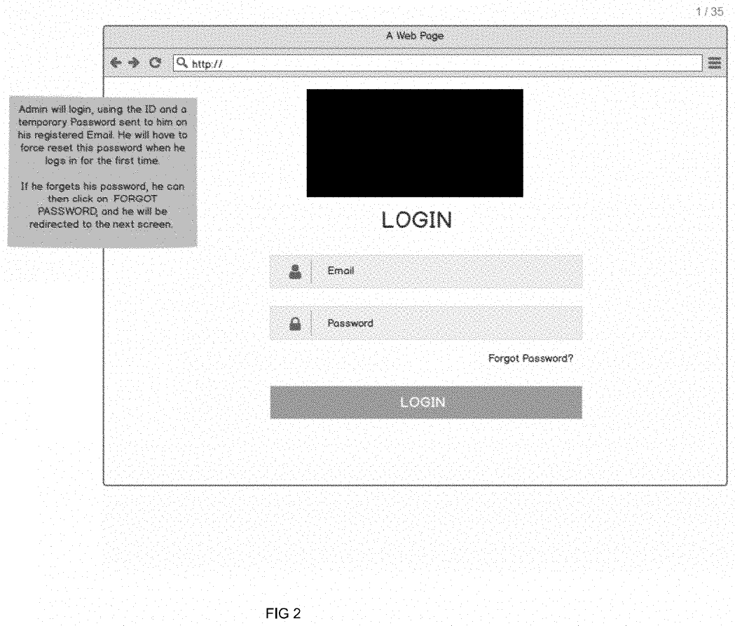

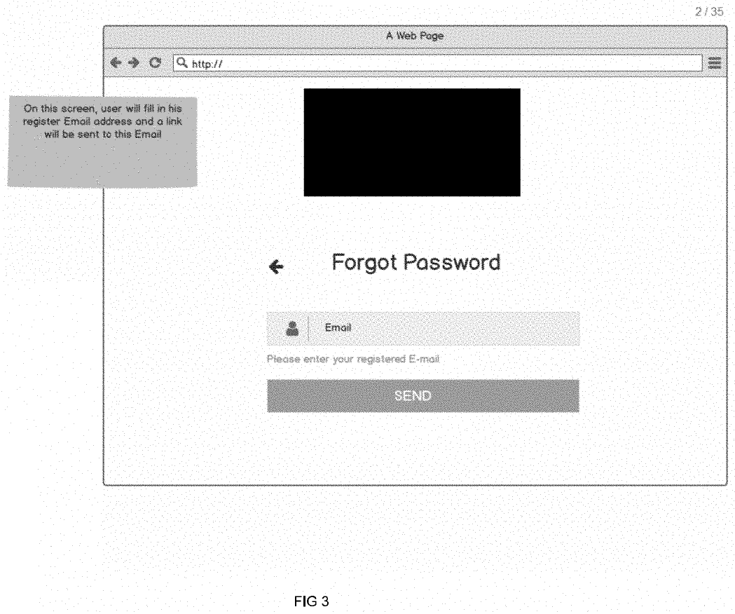

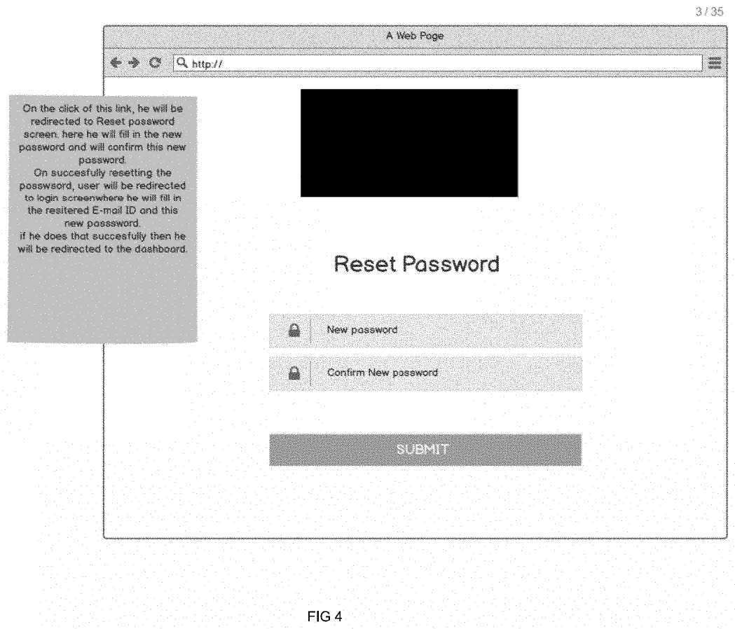

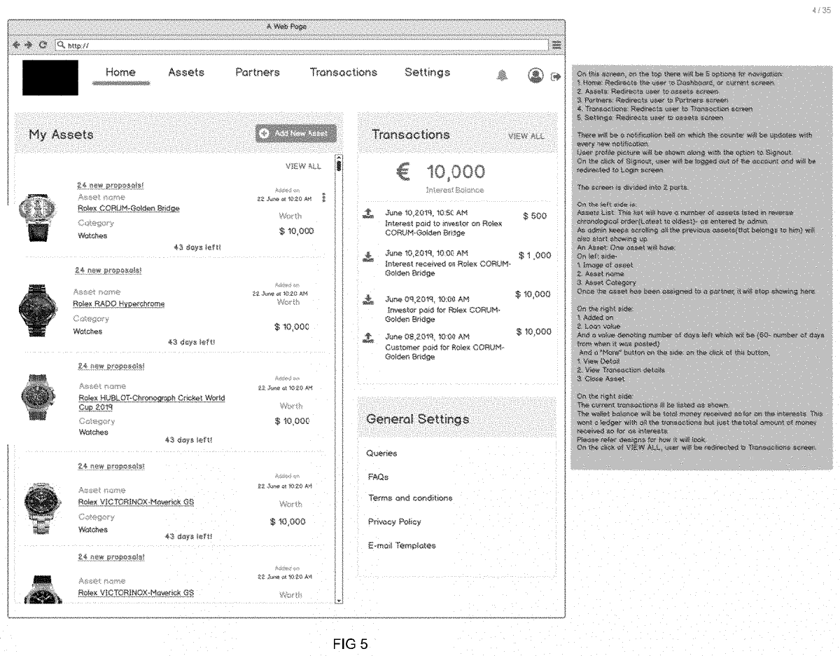

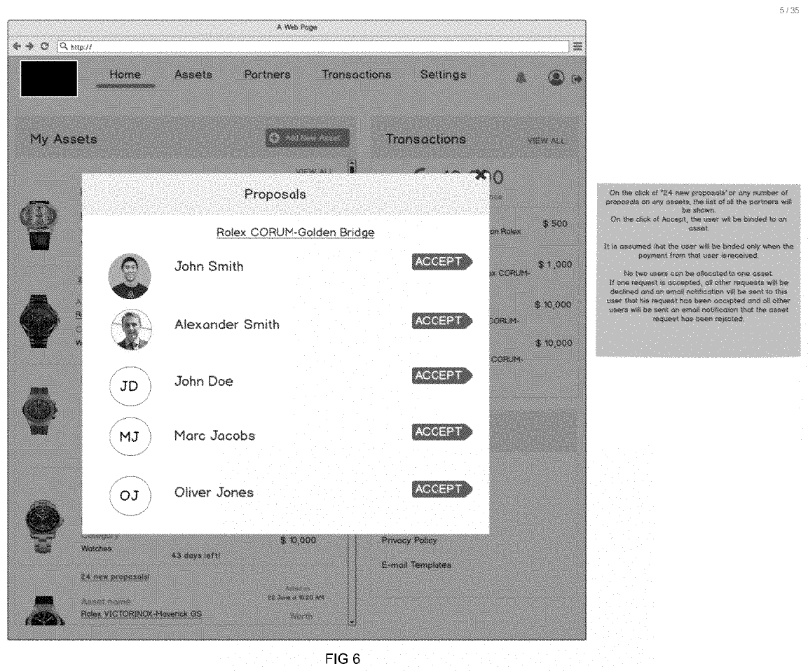

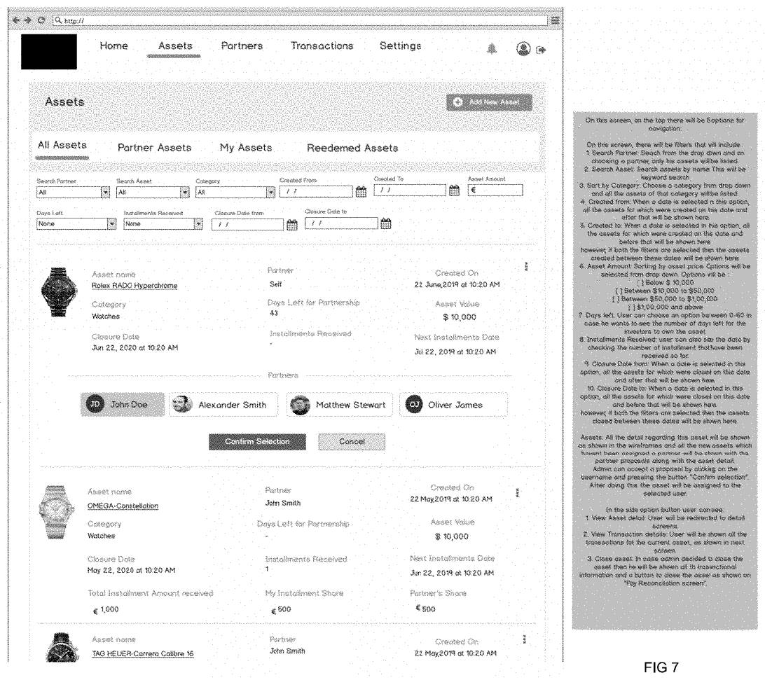

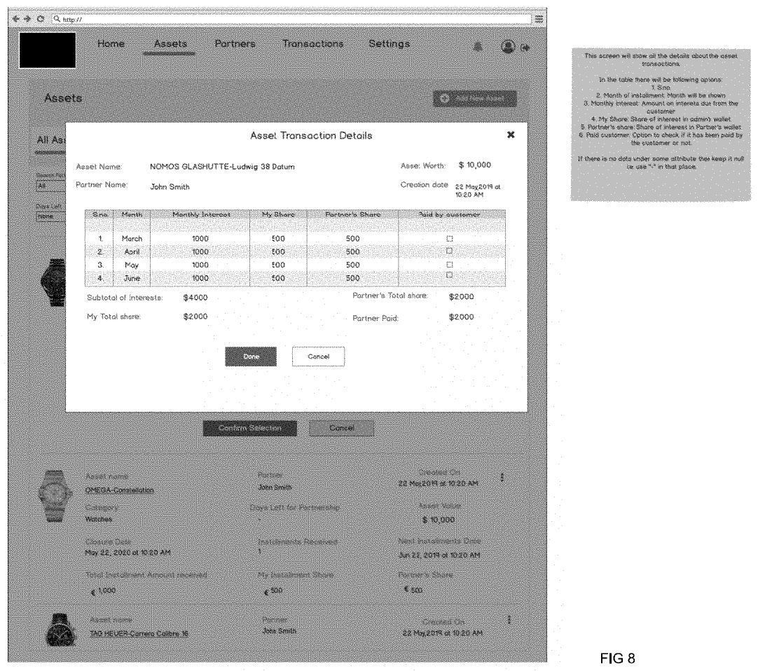

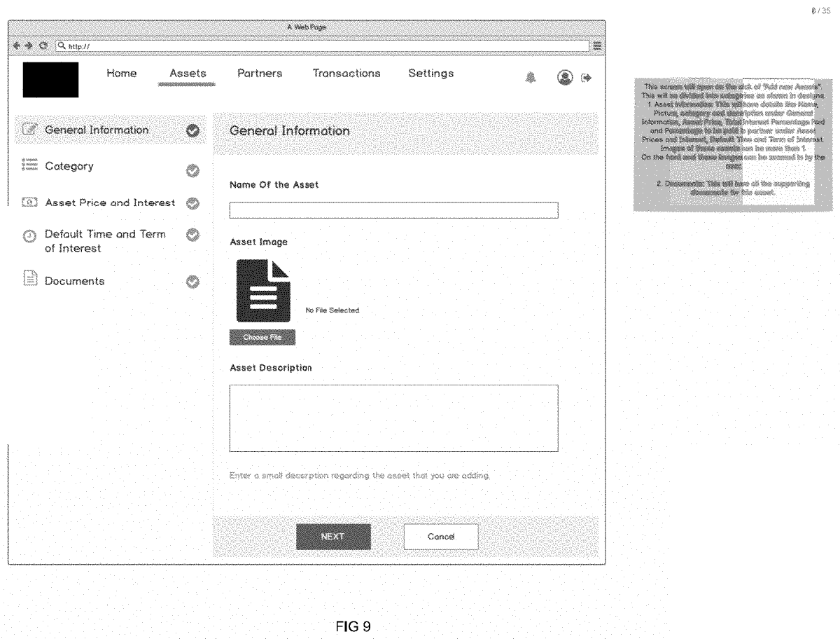

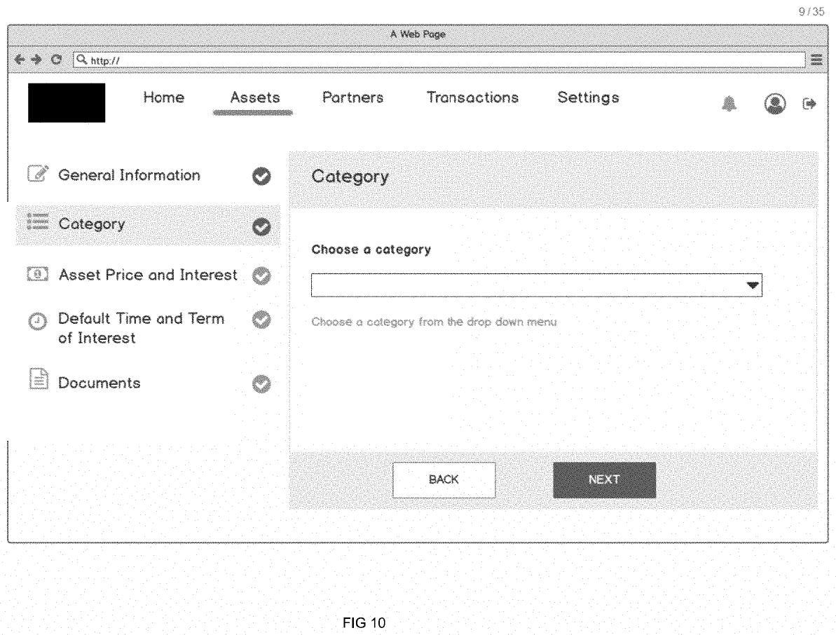

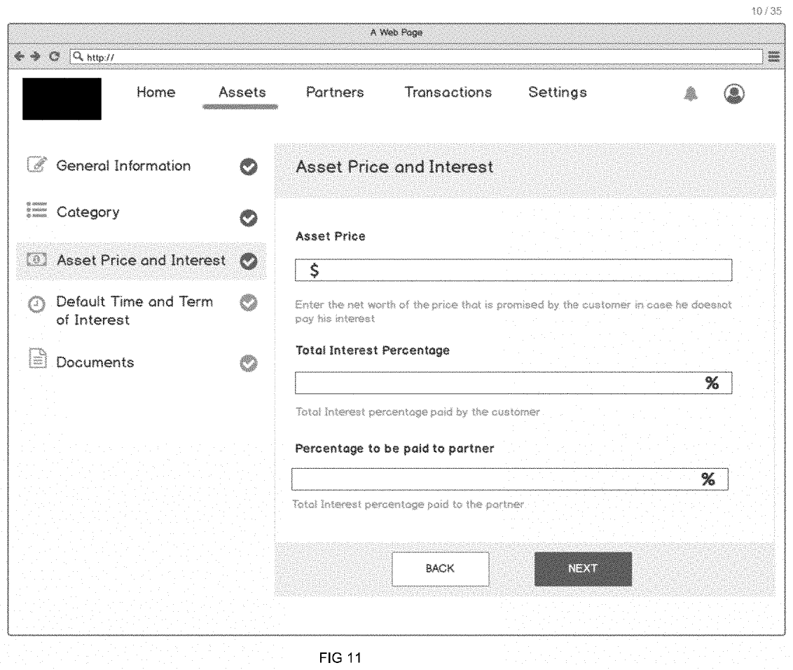

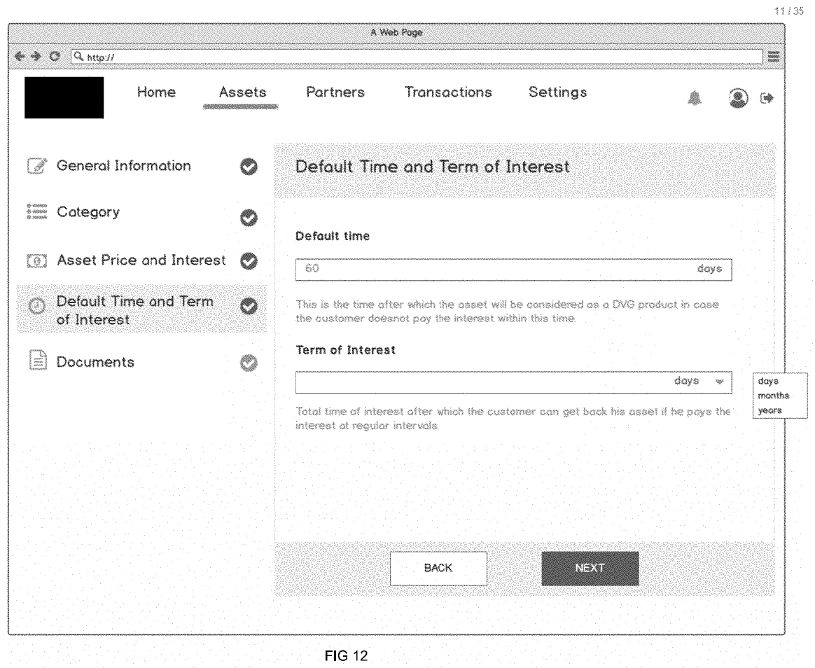

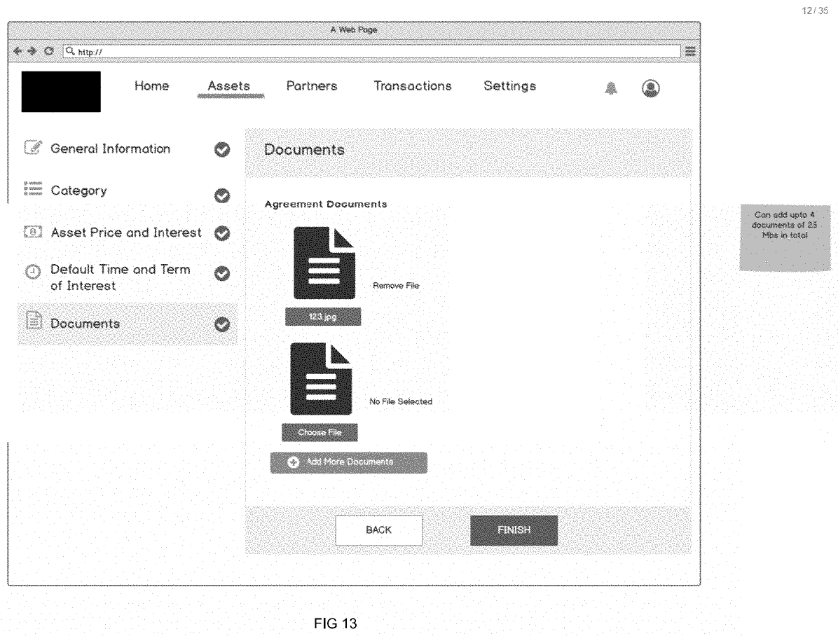

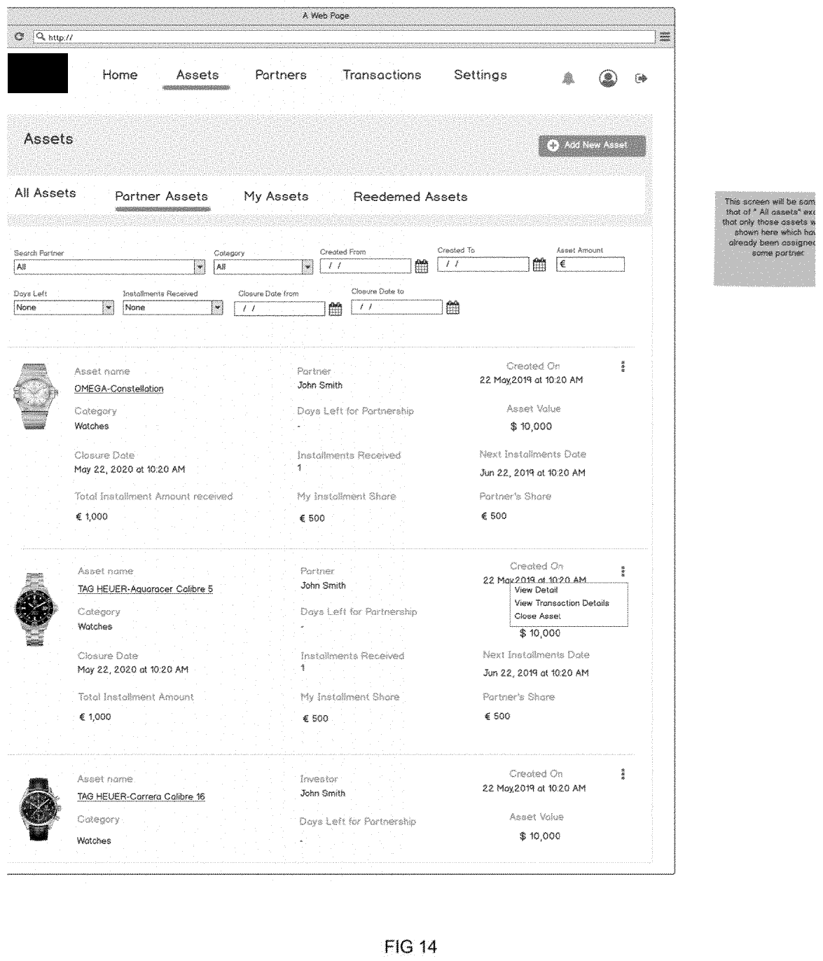

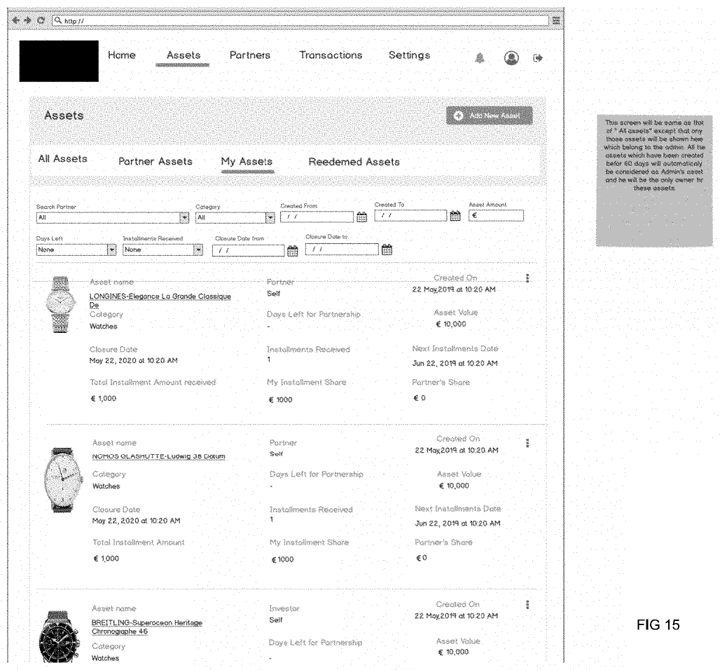

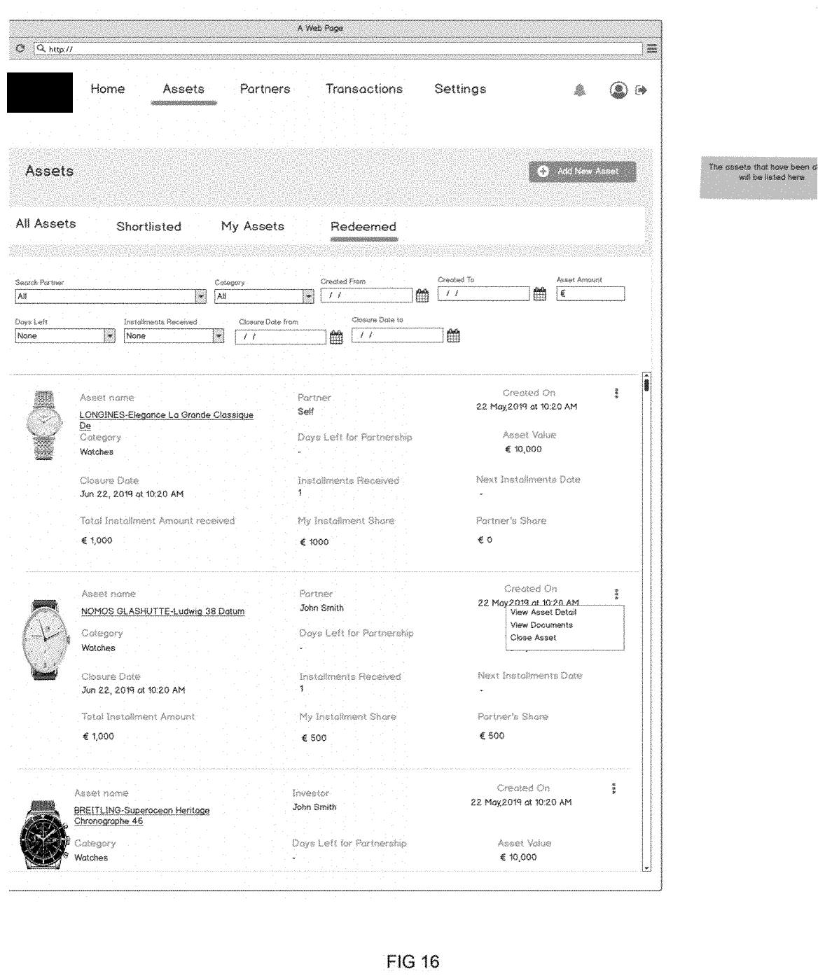

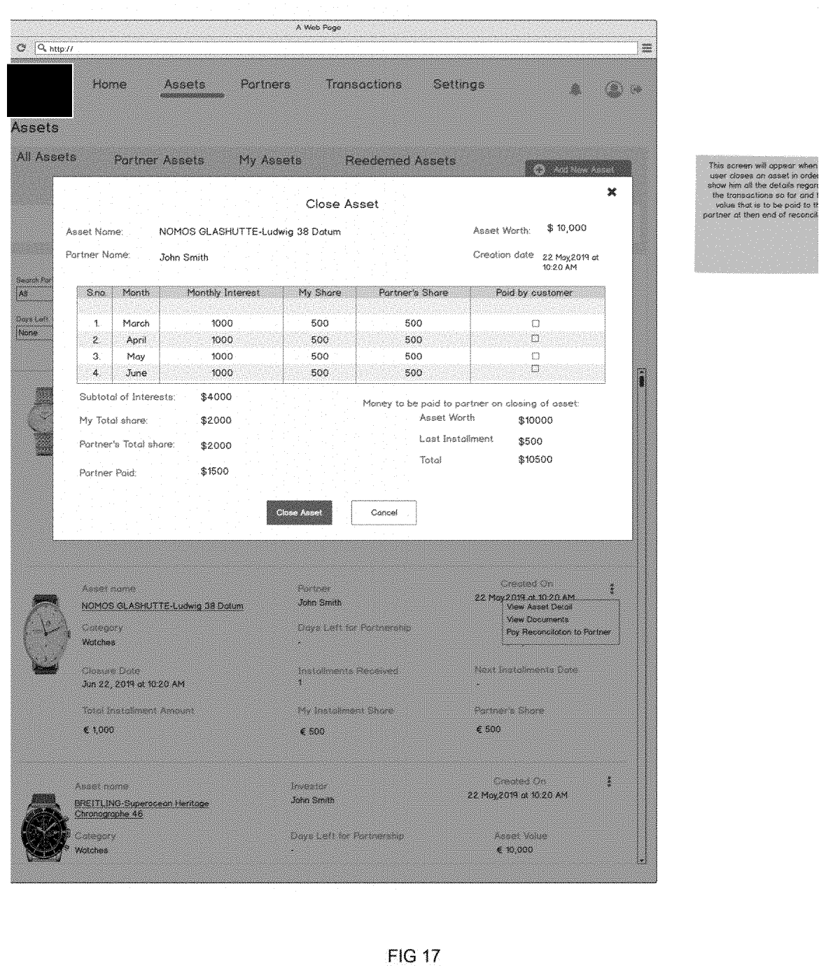

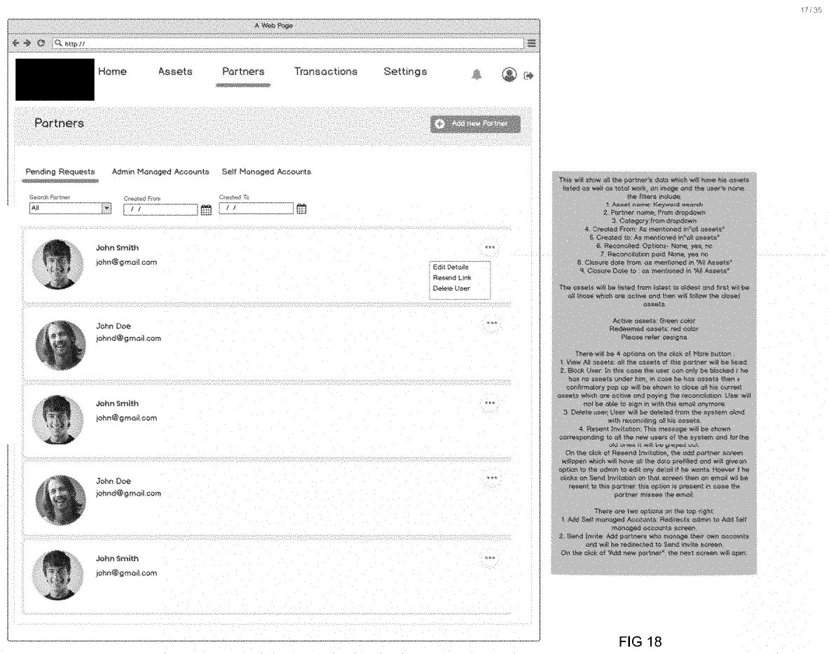

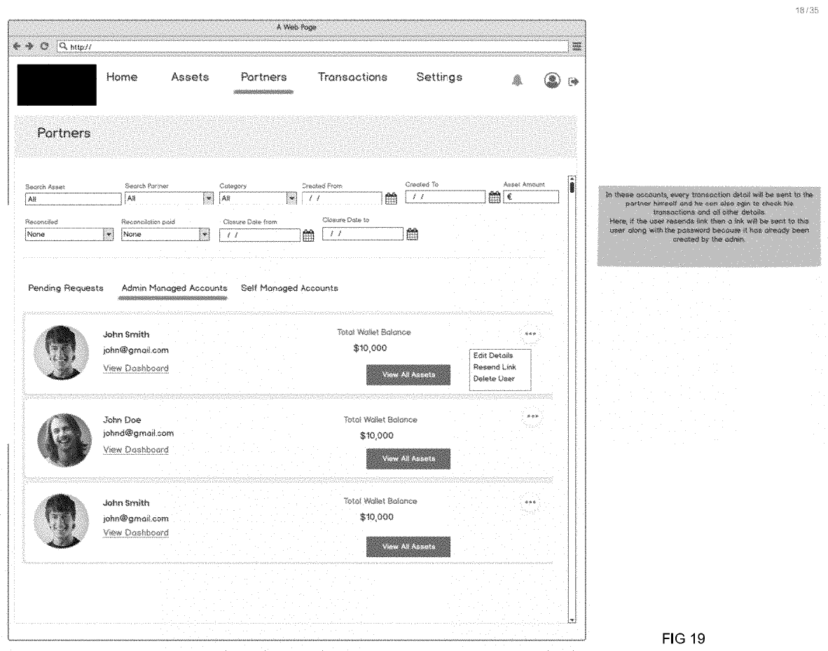

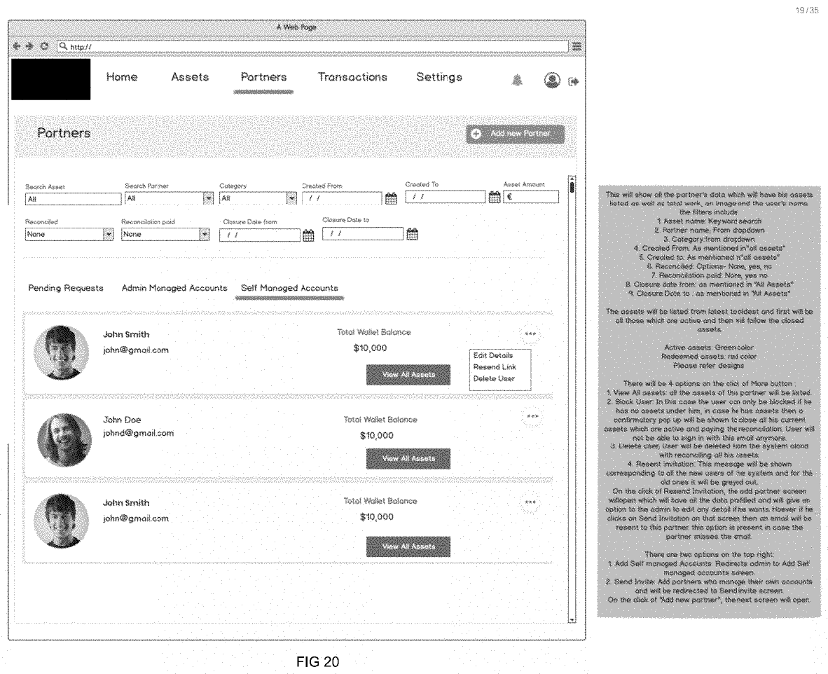

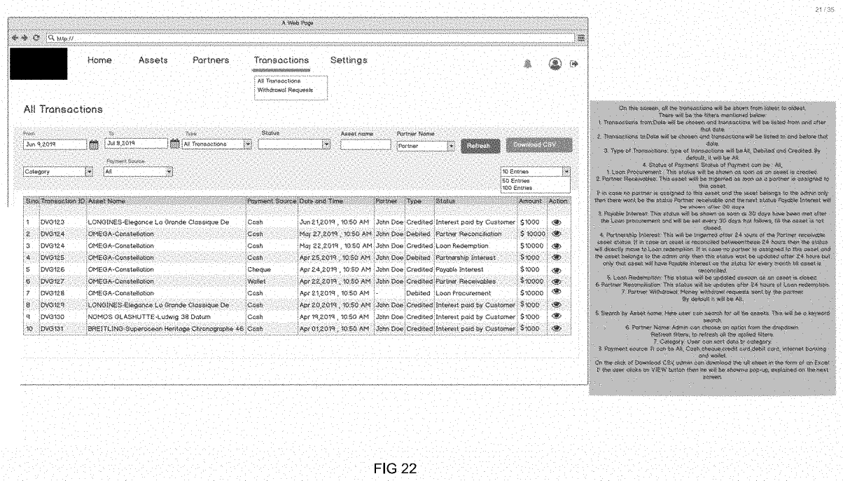

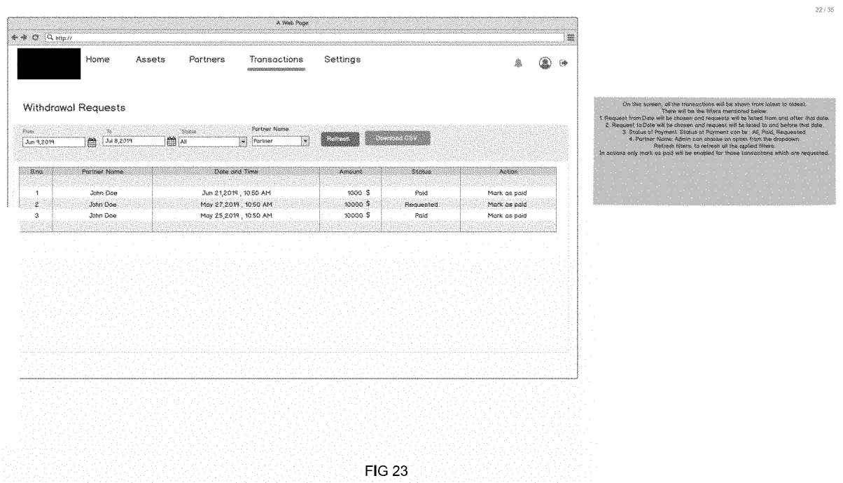

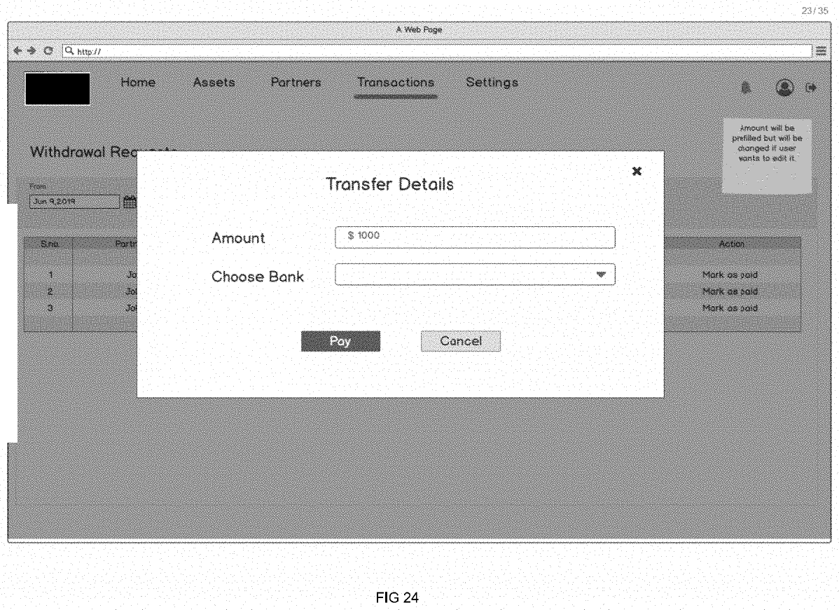

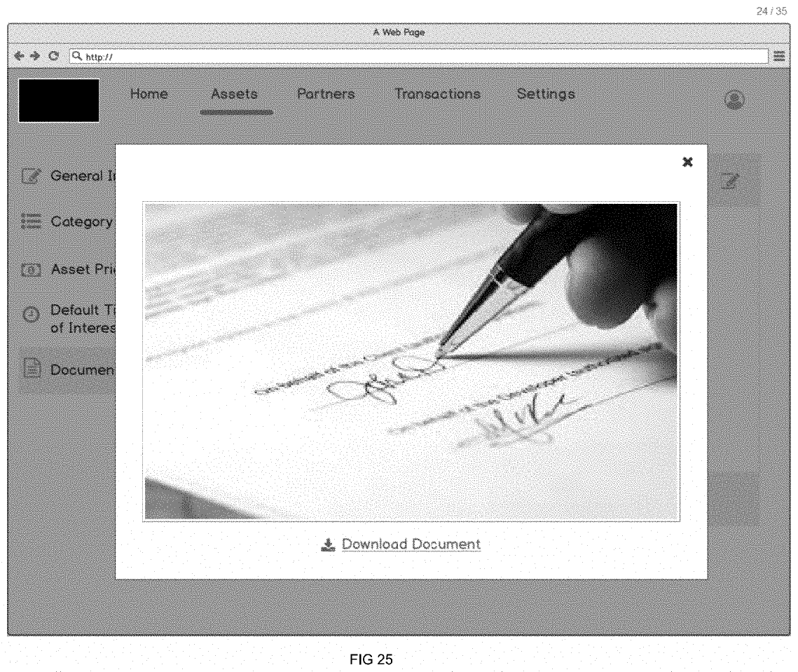

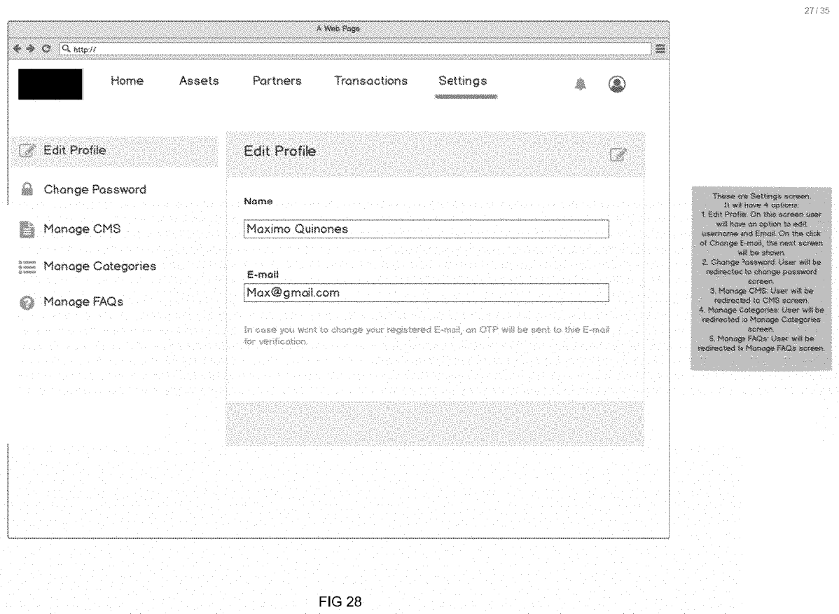

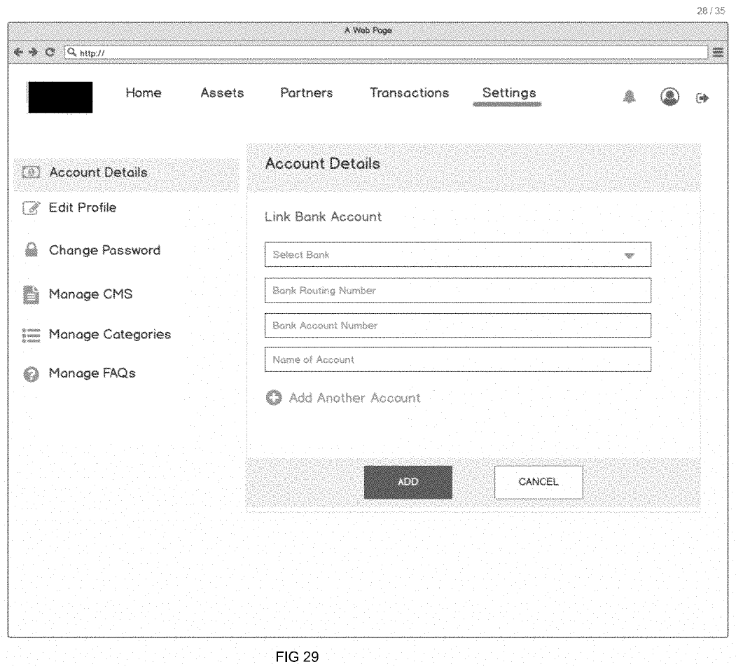

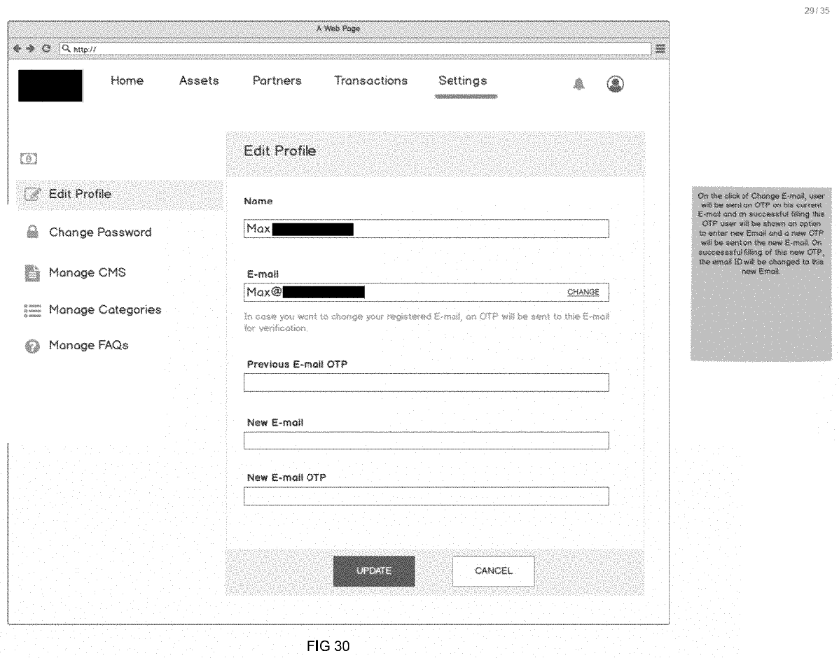

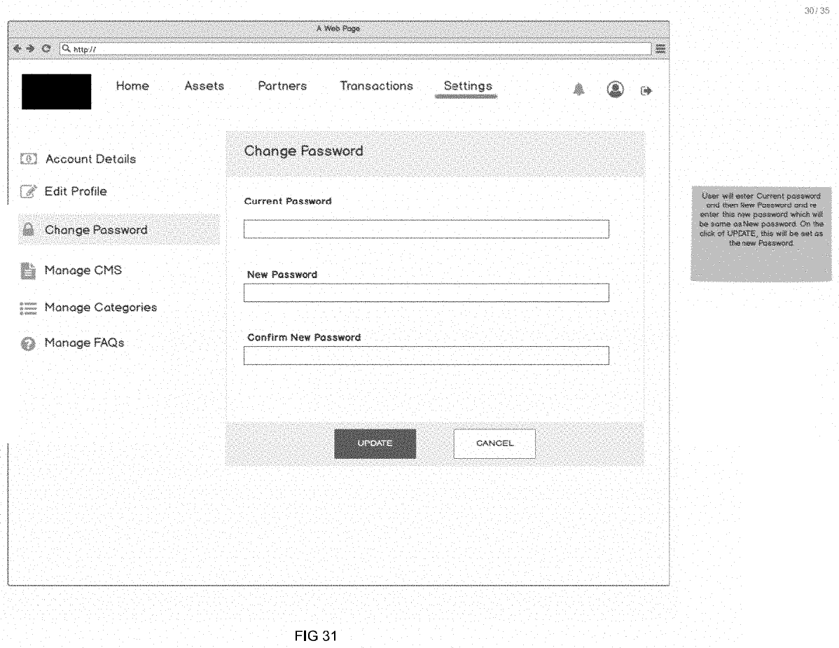

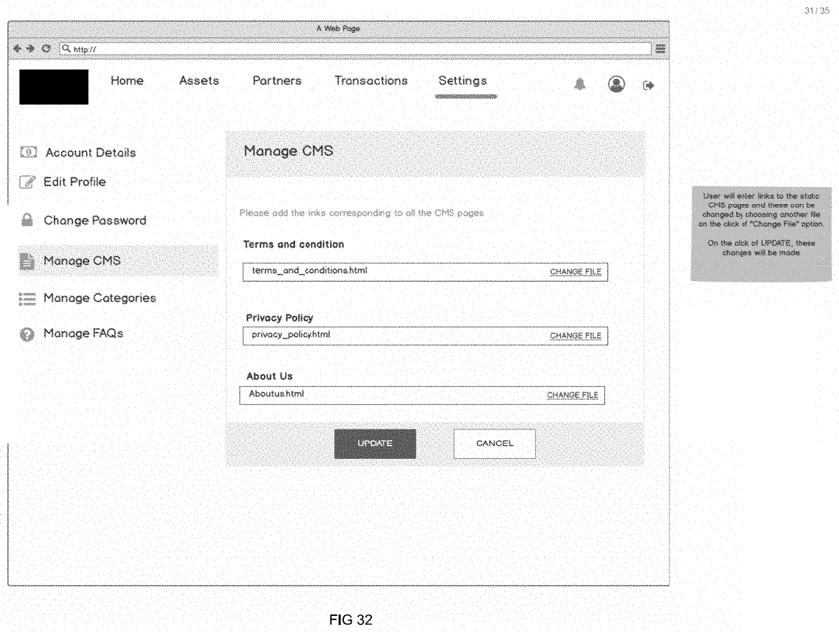

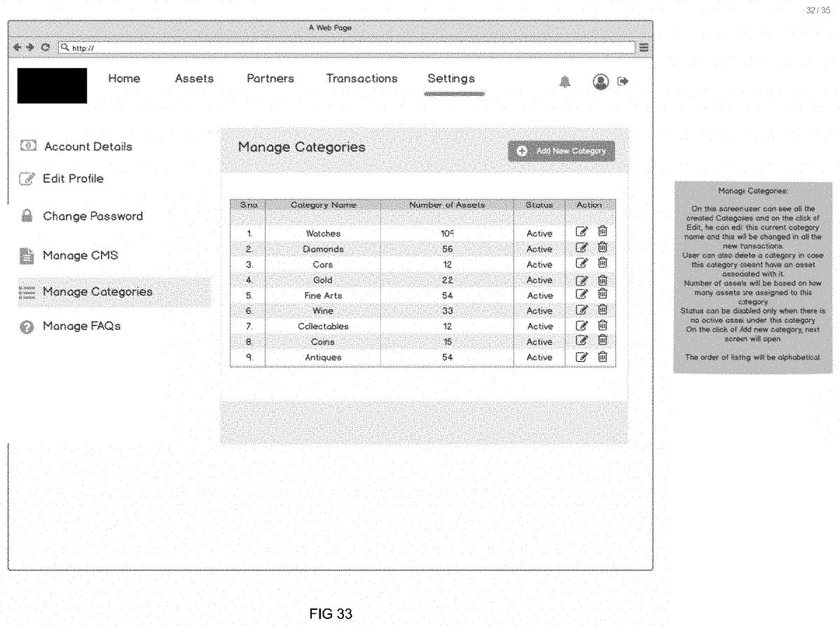

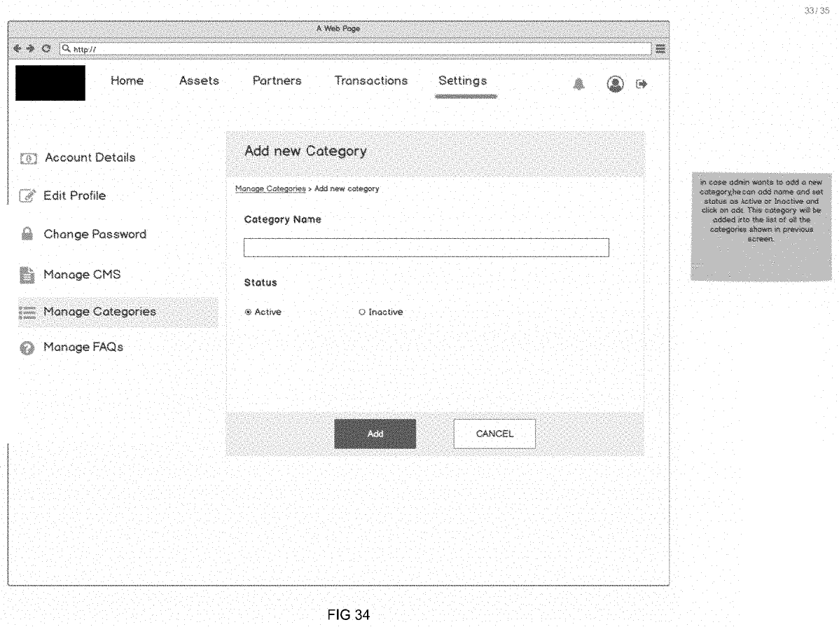

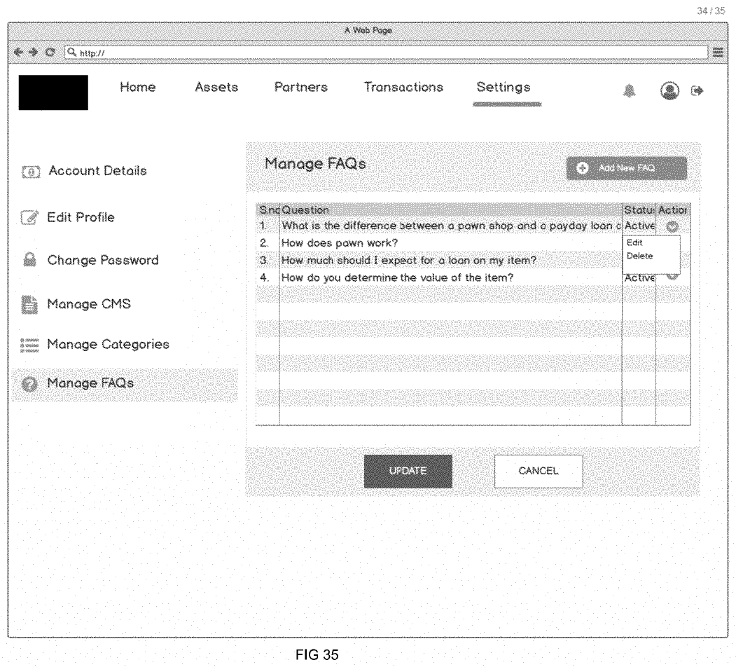

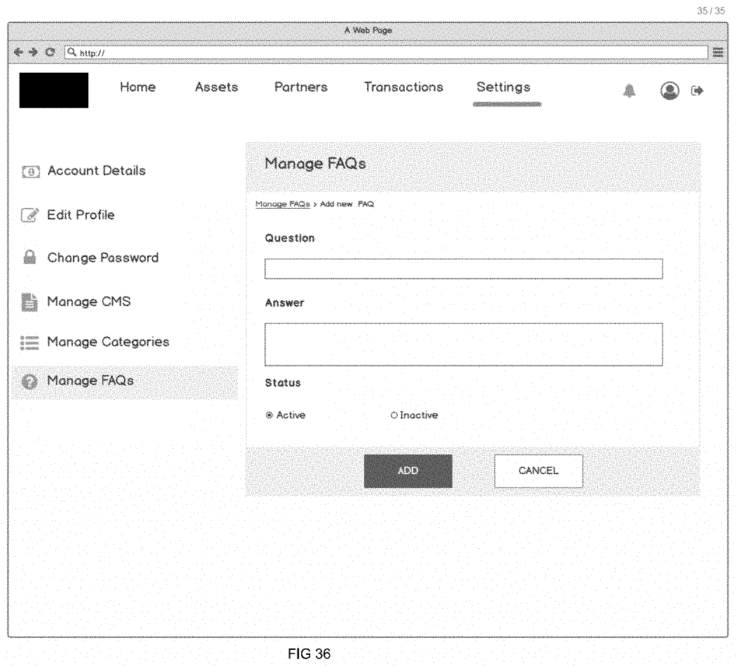

The accompanying figures, together with the description below are incorporated in and form part of the specification and serve to further illustrate various embodiments and to explain various principles and advantages all in accordance with the present invention. Trade names, proper names, logos and photos are depicted for reference only and are not intended to limit the disclosure. Furthermore, the application user interface and process flow depicted in FIGS. 2-36 are illustrative of one non-limiting embodiment of the present invention. Screenshots, wireframes, and diagrams accompany this disclosure and are labeled as FIG. 2 through FIG. 36. These figures represent screens of a graphical user interface such as what a registered user or licensee would encounter on a computer front-end or client-side computer. The user interface is the preferred mechanism though which a user interfaces, queries and receives information to and from the system or platform.

While the invention as claimed can be modified into alternative forms, specific embodiments thereof are shown by way of example in the drawings, figures, and wireframes and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

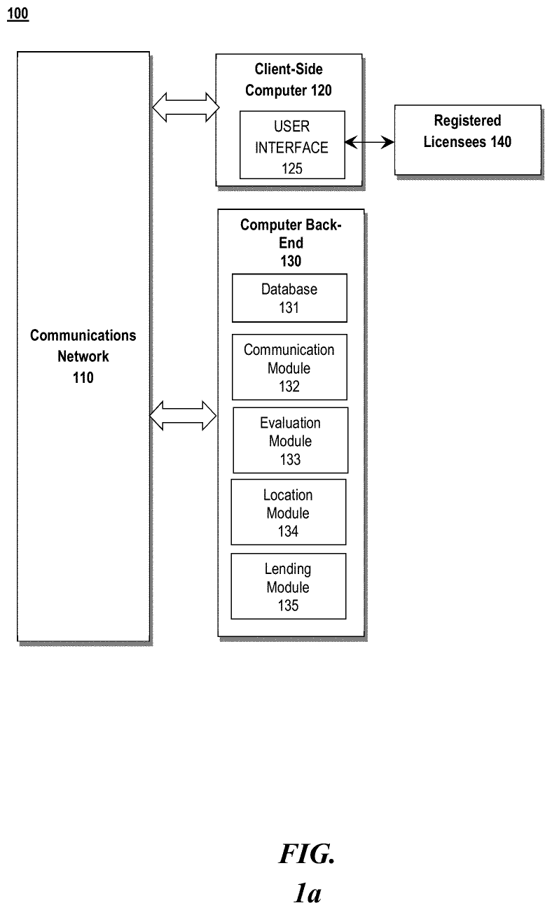

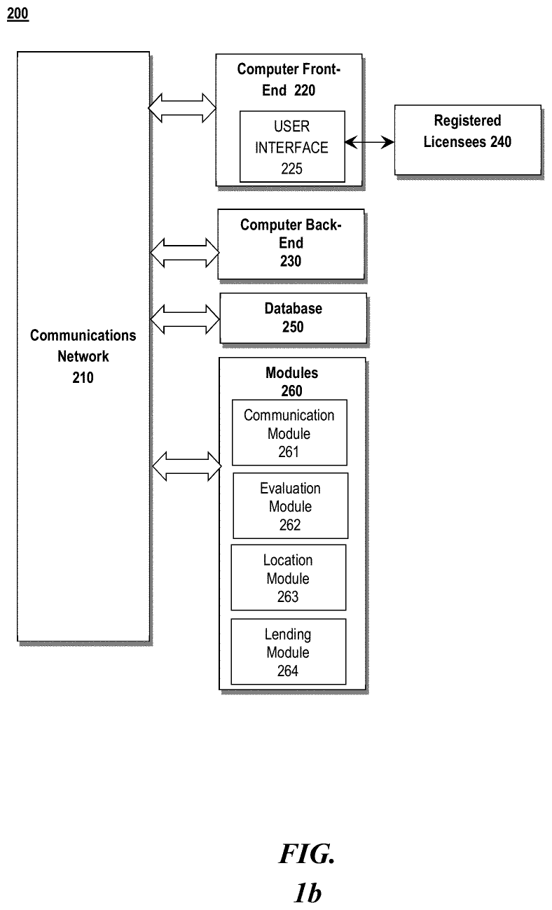

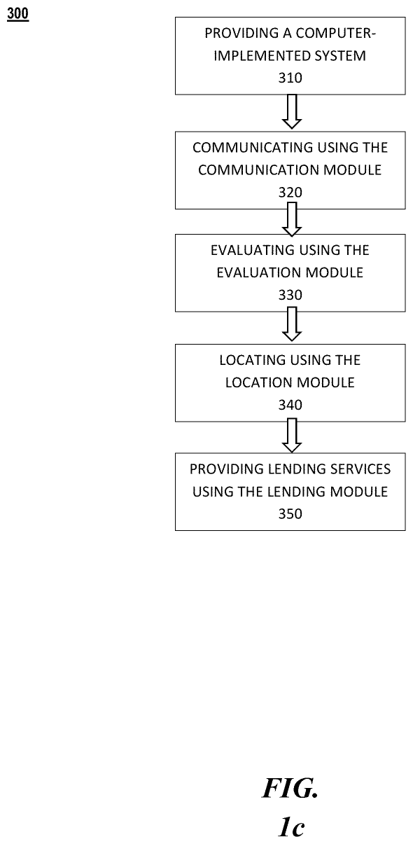

Referring now to the figures in general, and particularly to FIG. 1, according to one embodiment, an appraisal and asset-backed lending platform 100 is disclosed.

The platform 100 is accessed by one or more registered licensees 140 via a user interface 125. This user interface 125 is depicted as running on a client-side computer 120, but it will be known in the art that the client-side computer may be any user device that includes a processor, a memory, and a display/input/output mechanism and is also capable of connecting and communicating to a communications network 110. In embodiments, the client-side computer is a specially programmed PC that is configured to run the user interface 125, thereby improving the base functionality of the PC alone.

The user interface 125 is further adapted to only admit registered licensees 140 to access the appraisal and asset-backed lending platform 100.

Further, in operative connection with the communications network is a computer back-end 130 that is configured to be queried by (receive inputs from and send outputs to) the registered licensee 140 via the user interface 125. The computer back-end 130 may be accomplished, for example, by way of a specially-programmed computer server that is connected as a node on the communications network 110.

The computer back-end 130 also preferably includes a database 131 and one or more modules (132, 133, 134, 135) that improve the functionality of the computer back-end 130, so that a registered licensee 140, via the appraisal and asset-backed lending platform 100, can communicate, evaluate, locate, and lend.

Registered licensees 140 communicate with the appraisal and asset-backed community using the communication module 132 accessible via the user-interface 125.

Registered licensees 140 evaluate and appraise a variety of valuables in exchange for fees using the evaluation module 133 accessible via the user-interface 125.

Registered licensees 140 locate and know the position of valuables that have been appraised in order to generate potential leads for asset-backed loans using the location module 134 accessible via the user-interface 125.

Registered licensees 140 access lending services that are integrated as a feature of the lending module 135 accessible via the user-interface 125.

In embodiments, the registered licensees 140 are wholly-owned entities.

In other embodiments, the appraisal and asset-backed lending platform 100, further comprises a financial tool for funding into the platform by a contracted and wholly-owned financial services company.

In another embodiment of the present invention, a computer-implemented system 200 that provides a technological improvement over traditional appraisal and asset-backed lending systems includes a computer back-end 230 and computer front-end 220 that is configured to run over a communications network 210. The computers 220, 230 are specially-programmed to run one or more computer program instruction sets (modules 260) and interface with one or more databases 250. The system 200 provides a technological improvement over the prior art, as well as over the computers they run on, in that they are configured to provide a communication module 261, an evaluation module 262, a location module 263, and a lending module 264. Other modules, programs, or subroutines are contemplated to be included in the system, as may be known to a person of ordinary skill in the art, in order to provide the disclosed functionality. Interoperability, communication, and data transfer between modules is known in the art and improved upon as disclosed here.

The communication module 261 is configured to utilize the system 200 so that the system 200 and the user (registered licensee 240) can communicate with the appraisal and asset-backed community.

The evaluation module 262 (also referred to as the appraiser module) is configured to utilize the system 200 such that the system 200 and a user 240 can evaluate and appraise a variety of valuables in exchange for fees.

The location module 263 is configured to utilize the system 200 such that the system 200 and a user 240 can locate and know the position of valuables that have been appraised with the intention to generate potential leads for asset-backed loans.

The lending module 264 is configured to utilize the system 200 such that the system 200 and a user 240 can offer and service loans that are backed by the assets evaluated and managed within the system 200.

The system 200 can be implemented as discrete computing hardware each specially programmed to perform a particular function or the functions of a module 260. Alternatively, the system 200 can be implemented as a combination of computer hardware and programmed instruction sets programmed to run on the computer hardware. The system 200 may further be implemented as a “cloud service” where a user accesses a user 240 interface 225 via an internet protocol and the data is stored, processed, and retrieved remotely.

In another embodiment, a method 300 of utilizing the system 200 is disclosed. A computer-implemented method 300 for providing a technological improvement over traditional appraisal and asset-backed lending systems includes the steps of:

providing 310 a computer-implemented system having: a computer back-end; a computer front-end; a communications network wherein the computer back-end and the computer front-end are configured to communicate with each other over the communications network; and a one or more database accessible to either or both of the computer back-end and the computer front-end, wherein, either one or both of the computer back-end and the computer front-end are configured to provide a communication module, an evaluation module, a location module, and a lending module;

communicating 320 with the appraisal and asset-backed community using the communication module;

evaluating 330 and appraising a variety of valuables in exchange for fees using the evaluation module;

locating 340 and knowing the position of valuables that have been appraised in order to generate potential leads for asset-backed loans using the location module; and

providing 350 lending services using the lending module,

whereby, the computer-implemented method 300 provides a technological improvement over traditional appraisal and asset-backed lending systems.

From a user's perspective, a non-limiting embodiment of the present invention is shown in FIGS. 2-36. A user interface and login is provided as may be known in the art. Once logged in, a user will be presented with a graphical representation built from database queries related to their log-in and account information. In this embodiment, functionality is provided via a variety of modules presented as “pages” or “tabs”. As shown in this embodiment: HOME, ASSETS, PARTNERS, TRANSACTIONS, and SETTINGS.

HOME displays a configurable dashboard, for example, showing the user's assets and recent transactions.

ASSETS queries the database and presents a configurable display of assets. The user can view between ALL ASSETS, PARTNER ASSETS, MY ASSETS, and REDEEMED ASSETS.

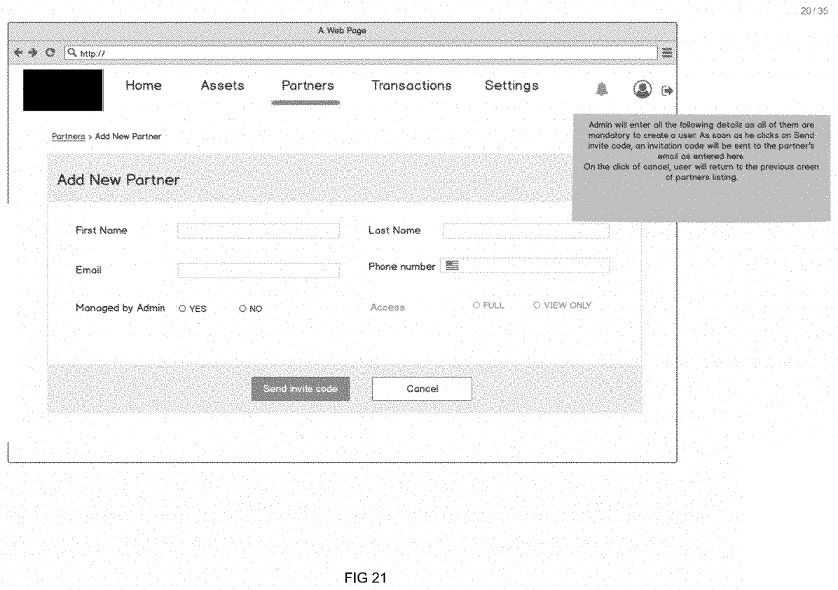

PARTNERS queries the database and presents a configurable display of other users of the system that have made a “partner” connection with the user. New partners can be added via invite (see FIG. 21).

TRANSACTIONS queries the database and presents a configurable display of transactions and data pertinent and stored for each transaction.

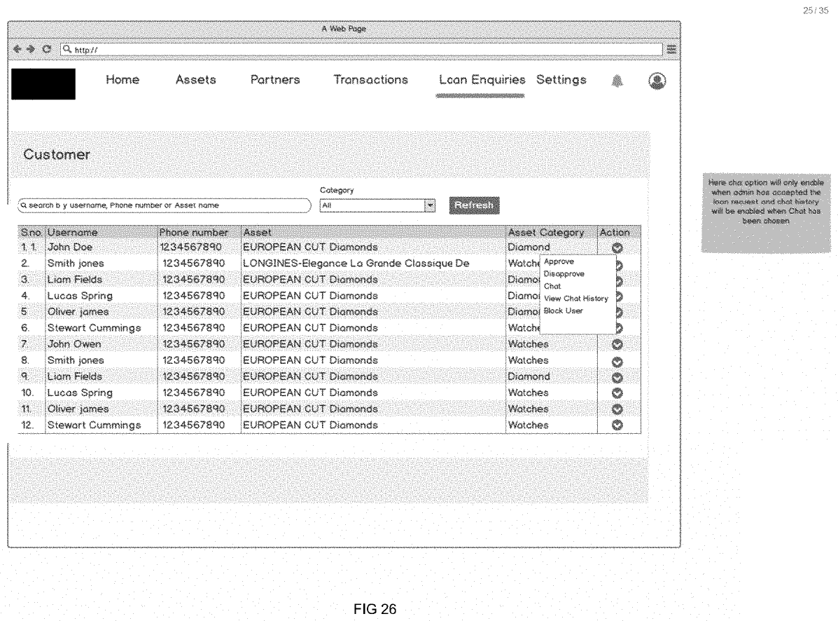

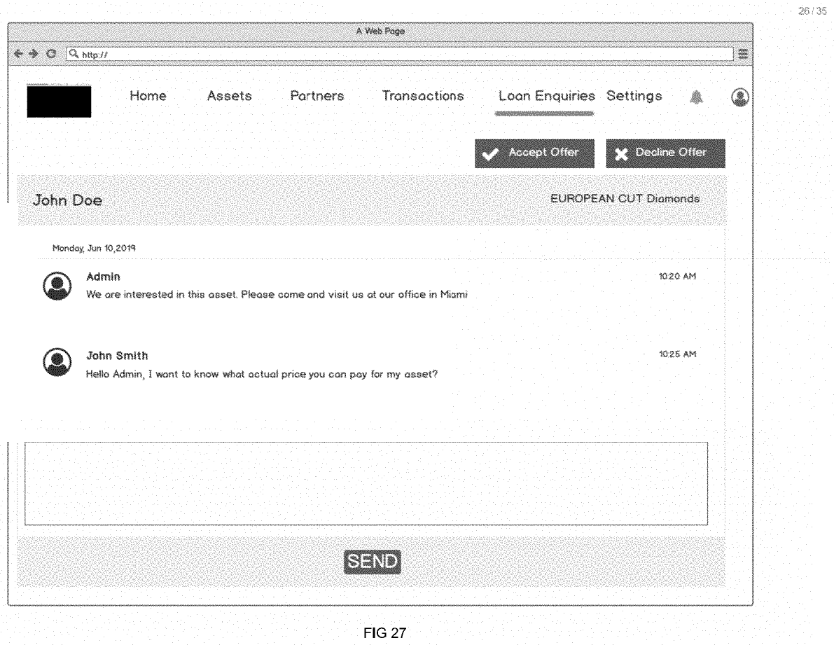

Additional tabs or modules may be added as needed. For example, FIGS. 26-27 show a LOAN ENQUIRIES tab which adds a “chat” functionality to the system.

SETTINGS provides the user various account and display settings and variables that are written to the database for later retrieval and tied to the account log-in.

Utilizing the disclosed system and method, the traditional “pawn shop” business model can be “de-centralized”, meaning that assets can be located in many different locations, but still be tracked, appraised and used as the backing for a lender to provide a loan. This is especially useful in situations where the asset is difficult to transport or when a lender desires to tap into a larger database of available assets for backing loans.

In an alternative embodiment, the platform grants a license to, as an example, ABC Pawn LLC, a wholly-owned entity (a pawn shop). ABC Pawn LLC uses the Finance Module to offer complete liquidity to all pawnshops within a geographical area in exchange for 2% monthly participation (or some other amount) in all pawns. In a Wholesale Model, clients are founder-operators looking to increase their cash on cash return and/or retirement, exit, etc.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims. Modifications and changes to the invention should be readily apparent to those having ordinary skill in the art, which modifications are intended to be within the spirit and scope of the invention as claimed. It is also understood that the foregoing description is illustrative of the present invention and should not be considered as limiting. Components from one embodiment can be combined with another embodiment and remain within the spirit and scope of the invention. Therefore, other embodiments of the present invention are possible without departing from the spirit and scope of the present invention.

1. An appraisal and asset-backed lending platform comprising:
a user-interface configured to run on a client-side computer that is in communication with a communications network, the user-interface adapted to admit only registered licensees to access the appraisal and asset-backed lending platform; and
a computer back-end in communication with the communications network, having a database that is configured to be queried by the registered licensee via the user-interface,
whereby, via the appraisal and asset-backed lending platform, a registered licensee can communicate, evaluate, locate, and lend.

2. The appraisal and asset-backed lending platform of claim 1, where registered licensees are wholly-owned entities.

3. The appraisal and asset-backed lending platform of claim 1, further comprising a financial tool for funding into the platform by a contracted and wholly-owned financial services company.

4. The appraisal and asset-backed lending platform of claim 1, where registered licensees communicate with the appraisal and asset-backed community using a communication module accessible via the user-interface.

5. The appraisal and asset-backed lending platform of claim 1, where registered licensees evaluate and appraise a variety of valuables in exchange for fees using an evaluation module accessible via the user-interface.

6. The appraisal and asset-backed lending platform of claim 1, where registered licensees locate and know the position of valuables that have been appraised in order to generate potential leads for asset-backed loans using a location module accessible via the user-interface.

7. The appraisal and asset-backed lending platform of claim 1, where registered licensees access lending services that are integrated as a feature of a lending module accessible via the user-interface.

8. A computer-implemented system that provides a technological improvement over traditional appraisal and asset-backed lending systems, the computer-implemented system comprising:
a computer back-end;
a computer front-end;
a communications network wherein the computer back-end and the computer front-end are configured to communicate with each other over the communications network; and
a one or more database accessible to either or both of the computer back-end and the computer front-end,
wherein, either one or both of the computer back-end and the computer front-end are configured to provide a communication module, an evaluation module, a location module, and a lending module.

9. The computer-implemented system of claim 8, where the communication module is configured to utilize the system such that the system and a user can communicate with the appraisal and asset-backed community.

10. The computer-implemented system of claim 8, where the evaluation module is configured to utilize the system such that the system and a user can evaluate and appraise a variety of valuables in exchange for fees.

11. The computer-implemented system of claim 8, where the location module is configured to utilize the system such that the system and a user can locate and know the position of valuables that have been appraised with the intention to generate potential leads for asset-backed loans.

12. The computer-implemented system of claim 8, where the lending module is configured to utilize the system such that the system and a user can offer and service loans that are backed by the assets evaluated and managed within the system.

13. A computer-implemented method for providing a technological improvement over traditional appraisal and asset-backed lending systems, the computer-implemented method comprising the steps of:
providing a computer-implemented system having:
a computer back-end;
a computer front-end;
a communications network wherein the computer back-end and the computer front-end are configured to communicate with each other over the communications network; and
a one or more database accessible to either or both of the computer back-end and the computer front-end,
wherein, either one or both of the computer back-end and the computer front-end are configured to provide a communication module, an evaluation module, a location module, and a lending module;
communicating with the appraisal and asset-backed community using the communication module;
evaluating and appraising a variety of valuables in exchange for fees using the evaluation module;
locating and knowing the position of valuables that have been appraised in order to generate potential leads for asset-backed loans using the location module; and
providing lending services using the lending module.
